(19) United States
(12) Patent Application Publication
(10) Pub. No.: US 2011/0080370 A1
(43) Pub. Date: Apr. 7, 2011

(54) TOUCH DEVICE

(76) Inventor: Tung-Ke Wu, Taipei City (TW)

(21) Appl. No.: 12/880,160

(22) Filed: Sep. 13, 2010

(30) Foreign Application Priority Data
Oct. 5, 2009 (TW) 098133773

(51) Int. Cl. G06F 3/045; G06F 3/041

(52) U.S. Cl. 345/174; 345/173

(57) ABSTRACT

A touch device includes a plurality of row electrodes, a plurality of column electrodes and a plurality of sensing units. The sensing units are used for detecting touched positions according to potentials of the row electrodes and column electrodes. The sensing units include at least a first sensing unit and a second sensing unit. The first sensing unit is coupled to a first portion of the row electrodes and a first portion of the column electrodes. The second sensing unit is coupled to a second portion of the row electrodes that is different from the first portion of the row electrodes, and a second portion of the column electrodes that is different from the first portion of the column electrodes.

### BACKGROUND OF THE INVENTION

1. Field of the Invention

The present invention relates to a touch device, and more particularly, to a touch device capable of shortening scanning time.

2. Description of the Prior Art

Buttons, keyboards or mice are generally utilized to input data into computer products. With the touch panels entrance to the market, however, users can input data in a more convenient fashion. Touch panels and related control devices are very common in modern portable products. Touch devices include projected capacitive touch devices and passive matrix resistive touch devices, wherein the projective capacitive touch devices are widely exploited in portable devices, e.g., cell phones and navigators for mobile vehicles due to features such as supporting multi-touch functionality, higher light transmittance, lower power consumption, etc. As the need for touch control on notebook computers increases, projected capacitive touch devices are also gradually being utilized in display panels with larger sizes. As the size of the display panel grows, the number of sensing electrodes is also increased for implementing the projected capacitive touch devices, and therefore more sensing chips are required to achieve accurate touch control functionality. The greater then number of sensing electrodes, however, the longer the time required to sense touch events. As a result, the speed of the touch device responding to a host (e.g., a cell phone or a computer) will decrease.

Please refer to FIG. 1. FIG. 1 is a diagram of a conventional projected capacitive touch device 100. The projected capacitive touch device 100 includes a plurality of row electrodes R₁˜Rₙ, a plurality of column electrodes C₁˜Cₘ which are perpendicular to the row electrodes R₁˜Rₙ, a first sensing unit 110 and a second sensing unit 120. The first sensing unit 110 includes a multiplexer 112 and an analog-to-digital converter (ADC) 114. The second sensing unit 120 also includes a multiplexer 122 and an ADC 124. The row electrodes R₁˜Rₙ and the column electrodes C₁˜Cₘ are utilized to sense potentials of capacitances, and the sensed potentials are processed by the ADCs 114 and 124 to thereby generate digital output voltages acting as output signals of the projected capacitive touch device 100. Furthermore, any one of the electrodes corresponds to an environment capacitance parameter according to its physical characteristic; therefore, when the projected capacitive touch device 100 is being touched, some variations will occur to analog output voltages of certain specific electrodes correspondingly. The first sensing unit 110 is coupled to the row electrodes R₁˜Rₙ for generating digital output voltages according to potential variations of the row electrodes R₁˜Rₙ to determine a location of the touch event; in addition, the second sensing unit 120 is coupled to the column electrodes C₁˜Cₘ for generating digital output voltages according to potential variations of the column electrodes C₁˜Cₘ to determine a location of the touch event

The projected capacitive touch device 100 determines a location of the touch event via a scanning process. During scanning, the row electrodes R₁˜Rₙ are responsible for providing potentials and the column electrodes C₁˜Cₘ are responsible for performing the sensing scanning, or the column electrodes C₁˜Cₘ are responsible for providing potentials and the row electrodes R₁˜Rₙ are responsible for performing the sensing scanning. That is, when the row electrodes R₁˜Rₙ are providing potentials, only the multiplexer 122 in the second sensing unit 120 will transmit voltage signals on the column electrodes C₁˜Cₘ to the following ADC 124 for sensing scanning, and when the column electrodes C₁˜Cₘ are providing potentials, only the multiplexer 112 in the first sensing unit 110 will transmit voltage signals on the row electrodes R₁˜Rₙ to the following ADC 114 for sensing scanning. In the conventional component arrangement, only one of the ADCs 114 and 124 is actually performing the sensing scanning action, such that the overall sensing scanning time cannot be optimized. Therefore, how to lower the scanning time of touch devices without increasing fabricating cost thereof is still a problem to be solved in this field.

### SUMMARY OF THE INVENTION

Therefore, one of the objectives of the present invention is to provide a touch panel capable of shortening the scanning time to solve the aforementioned problems.

According to an embodiment of the present invention, a touch device is provided. The touch device comprises a plurality of row electrodes, a plurality of column electrodes and a plurality of sensing units. The sensing units are used for detecting touched positions according to potentials of the row electrodes and column electrodes. The sensing units include at least a first sensing unit and a second sensing unit. The first sensing unit is coupled to a first portion of the row electrodes and a first portion of the column electrodes. The second sensing unit is coupled to a second portion of the row electrodes that is different from the first portion of the row electrodes, and coupled to a second portion of the column electrodes that is different from the first portion of the column electrodes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional projected capacitive touch device.

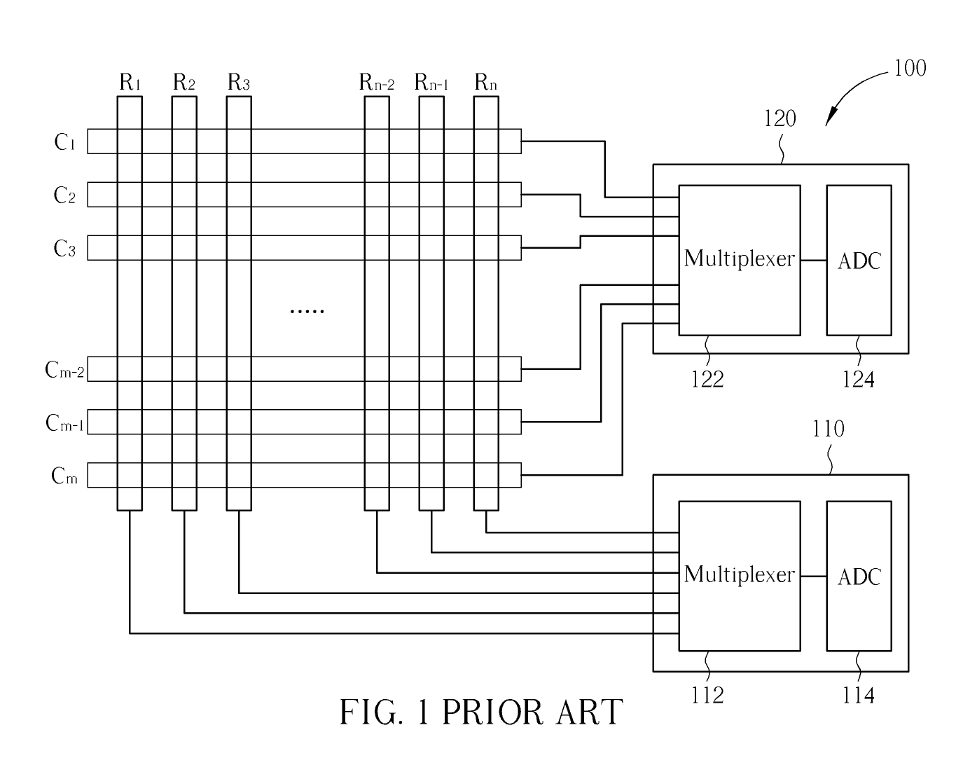

FIG. 2 is a diagram of a touch device according to an embodiment of the present invention.

FIG. 3 is a diagram of a touch device according to another embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

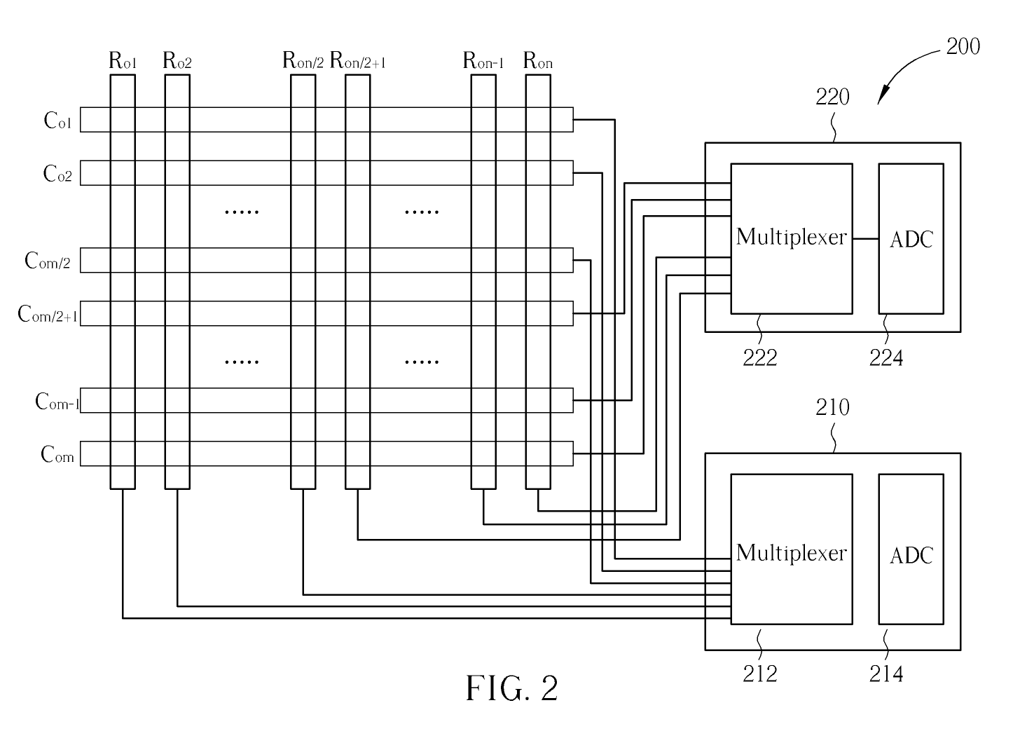

Please refer to FIG. 2. FIG. 2 is a diagram of a touch device according to an embodiment of the present invention. The touch device 200 includes (but is not limited to) a plurality of row electrodes Ro₁˜Roₙ, a plurality of column electrodes Co₁˜Coₘ perpendicular to the row electrodes Ro₁˜Roₙ, a first sensing unit 210 and a second sensing unit 220, wherein the row electrodes Ro₁˜Roₙ and the column electrodes Co₁˜Coₘ are all driving/sensing electrodes. The first sensing unit 210 includes a multiplexer 212 and a digital-to-analog converter (ADC) 214; likewise, the second sensing unit 220 includes a multiplexer 222 and an ADC 224. The row electrodes Ro₁˜Roₙ and the column electrodes Co₁˜Coₘ are utilized to sense potentials of capacitances and then digital output voltages acting as output signals of the touch device 200 are generated via ADCs 214 and 224. The first sensing unit 210 is coupled to a first portion Ro₁˜Ro_{n/2} of the row electrodes Ro₁˜Roₙ and a first portion Co₁˜Co_{m/2} of the column electrodes Co₁˜Coₘ, and is utilized to generate digital output voltages according to potential variations of the row electrodes Ro₁˜Ro_{n/2} and column electrodes Co₁˜Co_{m/2}, wherein the generated digital output voltages are used to determine the position of the touch event. The second sensing unit 220 is coupled to a second portion Ro_{n/2+1}˜Roₙ of the row electrodes Ro₁˜Roₙ and a second portion Co_{m/2+1}˜Coₘ of the column electrodes Co₁˜Coₘ, and is utilized to generate digital output voltages according to potential variations of the row electrodes Ro_{n/2+1}˜Roₙ and column electrodes Co_{m/2+1}˜Coₘ, wherein the generated digital output voltages are used to determine the position of the touch event.

During sensing scanning, if the row electrodes Ro₁˜Roₙ are utilized to provide potentials, the multiplexer 212 of the first sensing unit 210 and the multiplexer 222 of the second sensing unit 220 transmit voltage signals on the column electrodes Co₁˜Co_{m/2+1}, Co_{m/2+1}˜Coₘ to following ADCs 214 and 224, respectively; if the row electrodes Co₁˜Coₘ are utilized to provide potentials, the multiplexer 212 of the first sensing unit 210 and the multiplexer 222 of the second sensing unit 220 transmit voltage signals on the row electrodes Ro₁˜Ro_{n/2}, Ro_{n/2+1}˜Roₙ to following ADCs 214 and 224, respectively.

Therefore, during the sensing scanning procedure, no matter whether the row electrodes Ro₁˜Roₙ or the column electrodes Co₁˜Coₘ are used to provide potentials, the ADCs 214 and 224 can simultaneously perform sensing scanning, which efficiently reduces the overall time required for sensing scanning.

Please note that, in the aforementioned embodiments, the electrode number of the first portion Co₁˜Co_{m/2} of the column electrodes is equal to the electrode number of the second portion Co_{m/2+1}˜Coₘ of the column electrodes, the electrode number of the first portion Ro₁˜Ro_{n/2} of the row electrodes is equal to the electrode number of the second portion Ro_{n/2+1}˜Roₙ of the row electrodes, the first portion Ro₁˜Ro_{n/2} and the second portion Ro_{n/2+1}˜Roₙ of the row electrodes have a plurality of sequential row electrodes, respectively, and the first portion Co₁˜Co_{m/2} and the second portion Co_{m/2+1}˜Coₘ of the column electrodes have a plurality of sequential column electrodes, respectively; however, the aforementioned arrangement of the row electrodes Ro₁˜Roₙ and the column electrodes Co₁˜Coₘ is for illustrative purposes only, i.e., evenly distributing the row electrodes Ro₁˜Roₙ and the column electrodes Co₁˜Coₘ to a plurality of sensing units is only a preferred embodiment of the present invention. Without departing from the spirit of the present invention (i.e., a single sensing unit coupled to different kinds of electrodes instead of coupled to one single kind of electrode), other arrangements of the row electrodes Ro₁˜Roₙ and the column electrodes Co₁˜Coₘ are feasible and still fall within the scope of the present invention. For example, as long as the electrode number of the first portion of the row electrodes is equal to the electrode number of the second portion of the row electrodes, the electrode number of the first portion of the column electrodes is equal to the electrode number of the second portion of the column electrodes, the first portion of the row electrodes has a plurality of sequential row electrodes, the second portion of the row electrodes has a plurality of sequential row electrodes, the first portion of the column electrodes has a plurality of sequential column electrodes, or the second portion of the column electrodes has a plurality of sequential column electrodes, it should be categorized within the scope of the present.

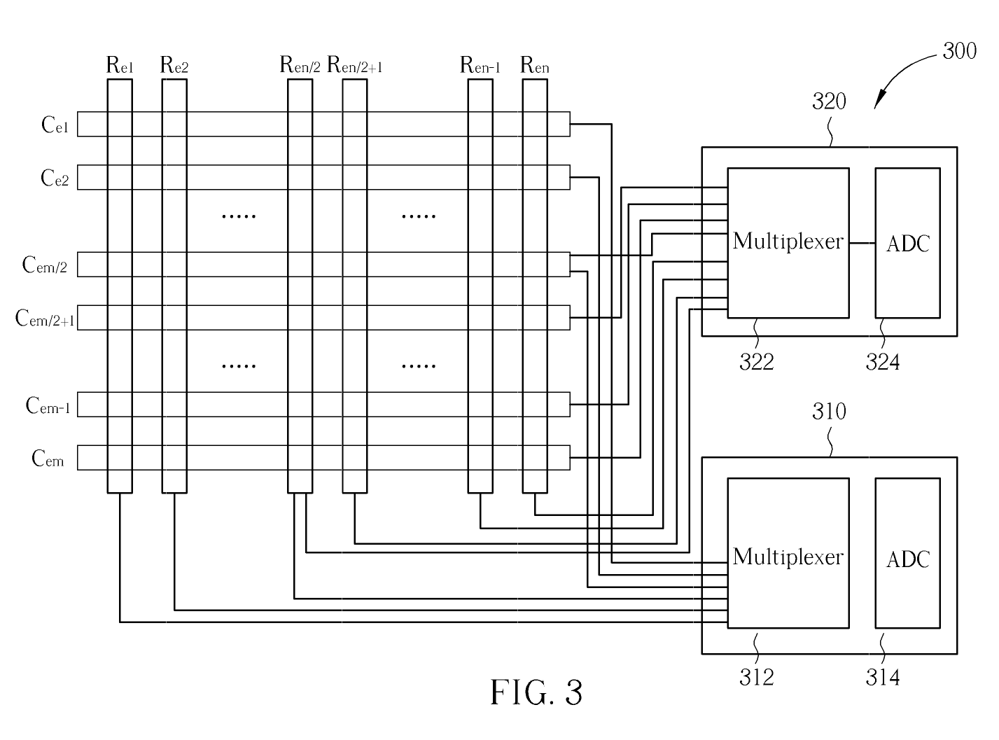

Please refer to FIG. 3. FIG. 3 is a diagram of a touch device according to another embodiment of the present invention. The touch device 300 includes (but is not limited to) a plurality of row electrodes Re₁˜Reₙ, a plurality of column electrodes Ce₁˜Ceₘ perpendicular to the electrodes Re₁˜Reₙ, a first sensing unit 310 and a second sensing unit 320, wherein the row electrodes Re₁˜Reₙ and the column electrodes Ce₁˜Ceₘ are all driving/sensing electrodes. The first sensing unit 310 includes a multiplexer 312 and an ADC 314; likewise, the second sensing unit 320 includes a multiplexer 322 and an ADC 324. The row electrodes Re₁˜Reₙ and the column electrodes Ce₁˜Ceₘ are utilized to sense potentials of capacitances, and then digital output voltages acting as output signals of the touch device 300 are generated via the ADCs 314 and 324. The first sensing unit 312 is coupled to a first portion Re₁˜Re_{n/2} of the row electrodes Re₁˜Reₙ and a first portion Ce₁˜Ce_{m/2} of the column electrodes Co₁˜Coₘ, and is utilized to generate digital output voltages according to potential variations of the row electrodes Re₁˜Re_{n/2} and column electrodes Ce₁˜Ce_{m/2}, wherein the generated digital output voltages are used to determine the position of the touch event. The second sensing unit 320 is coupled to a second portion Re_{n/2}˜Reₙ of the row electrodes Re₁˜Reₙ and a second portion Ce_{m/2}˜Ceₘ of the column electrodes Ce₁˜Ceₘ, and is utilized to generate digital output voltages according to potential variations of the row electrodes Re_{n/2}˜Reₙ and column electrodes Ce_{m/2}˜Ceₘ, wherein the generated digital output voltages are used to determine the position of the touch event. The difference between the touch device 300 in FIG. 3 and the touch device 200 FIG. 2 is that the first sensing unit 310 and the second sensing unit 320 are coupled to the row electrode Re_{n/2} and the column electrode Ce_{m/2} simultaneously. In this way, the touch device 300 can perform sensing scanning to determine the position of the touch event more accurately.

The aforementioned embodiments are only for describing the technical characteristics of the present invention, and are not meant to be taken as limitations to the scope of the present invention. To summarize, the present invention provides a touch device capable of shortening sensing scanning time by assigning row electrodes and column electrodes to a plurality of sensing units properly. During the sensing scanning procedure, no matter whether row electrodes or column electrodes are utilized for providing potentials, the ADCs in the sensing units can perform sensing scanning simultaneously, thereby effectively reducing the overall time required for completing the sensing scanning.

Those skilled in the art will readily observe that numerous modifications and alterations of the device and method may be made while retaining the teachings of the invention.

What is claimed is:

1. A touch device, comprising:
a plurality of row electrodes;
a plurality of column electrodes; and
a plurality of sensing units, for detecting touched positions according to potentials of the row electrodes and the column electrodes, comprising:
at least a first sensing unit, coupled to a first portion of the row electrodes and a first portion of the column electrodes; and
at least a second sensing unit, coupled to a second portion of the row electrodes that is different from the first portion of the row electrodes, and coupled to a second portion of the column electrodes that is different from the first portion of the column electrodes.

2. The touch device of claim 1, further comprising:
a row electrode, coupled to the first sensing unit and the second sensing unit.

3. The touch device of claim 2, further comprising:
a column electrode, coupled to the first sensing unit and the second sensing unit.

4. The touch device of claim 1, wherein an electrode number of the first portion of the row electrodes is equal to an electrode number of the second portion of the row electrodes.

5. The touch device of claim 4, wherein an electrode number of the first portion of the column electrodes is equal to an electrode number of the second portion of the column electrodes.

6. The touch device of claim 1, wherein an electrode number of the first portion of the column electrodes is equal to an electrode number of the second portion of the column electrodes.

7. The touch device of claim 1, wherein the first portion of the row electrodes comprises a plurality of sequential row electrodes of the row electrodes.

8. The touch device of claim 1, wherein the first portion of the column electrodes comprises a plurality of sequential column electrodes of the column electrodes.

9. The touch device of claim 1, wherein the second portion of the row electrodes comprises a plurality of sequential row electrodes of the row electrodes.

10. The touch device of claim 1, wherein the second portion of the column electrodes comprises a plurality of sequential column electrodes of the column electrodes.

11. The touch device of claim 1, wherein the row electrodes and the column electrodes are all driving/sensing electrodes.

12. The touch device of claim 1, being a capacitive touch panel.
